(19) United States
(12) Patent Application Publication
(10) Pub. No.: US 2012/0006685 A1
(43) Pub. Date: Jan. 12, 2012

(54) Process for Preparing Composite Membranes

(75) Inventor: Ronny Van Engelen, Tilburg (NL)

(73) Assignee: FUJIFILM MANUFACTURING EUROPE B.V., Tilburg (NL)

(21) Appl. No.: 13/257,075

(22) PCT Filed: Mar. 16, 2010
(86) PCT No.: PCT/GB2010/050447

§ 371 Date: Sep. 16, 2011

(30) Foreign Application Priority Data
Mar. 17, 2009 (GB) 0904560.0

(51) Int. Cl. B01D 61/46; B32B 3/26; B05D 3/12; B05D 3/06; B05D 3/02; B05D 5/00

(52) U.S. Cl. 204/627; 427/372.2; 427/356; 427/355; 427/348; 427/532; 427/558; 427/551; 428/304.4

(57) ABSTRACT

A continuous process for preparing a composite membrane comprising the steps of: (i) providing a laminate structure comprising a barrier layer and a porous sheet; (ii) applying a curable composition to the porous sheet; (iii) curing the composition to form the composite membrane comprising the sheet and the cured composition; and (iv) optionally separating the composite membrane from the barrier layer. The composite membranes are particularly useful for producing electricity by reverse electrodialysis.

This invention relates to composite membranes, to a process for their preparation and to the use of such composite membranes, e.g. in reverse dialysis.

Global warming and high fossil fuel prices have accelerated interest in renewable energy sources. The most common sources of renewable energy are wind power and solar power. Harvesting wind power using turbines is increasingly common, although many regard the turbines as unsightly and they are ineffective in low wind and on very windy days. Solar power is also weather dependent and not particularly efficient in countries far from the hemisphere.

The principle of using reverse electrodialysis (RED) to generate power from seawater and fresh water was described for the first time in 1954 by R. Plattle in Nature. Experimental results were obtained in America and Israel in the seventies. U.S. Pat. No. 4,171,409 is an early example of innovation in this field. KEMA in the Netherlands revived the investigation into RED in 2002 under the name “blue energy”, winning the Dutch Innovation Award for 2004 in the category “Energy and Environment”. In the Netherlands there is a particular interest in this technology due to the abundant supply of fresh/brackish water and salty water in close proximity.

The use of RED to produce electricity was discussed in the paper by Turek et al, Desalination 205 (2007) 67-74. Reverse dialysis (RED) gets its name from the fact that it is the reverse of conventional dialysis—instead of using electricity to desalinate sea water, energy is generated from the mixing of salty water with less salty water (typically sea water with fresh or brackish water). Djugolecki et al, J. of Composite membrane Science, 319 (2008) 214-222 discuss the most important composite membrane properties for RED.

In RED two types of composite membrane are used, namely one that is selectively permeable for positive ions and one that is selectively permeable for negative ions. Salt water isolated from fresh water between two such composite membranes will lose both positive ions and negative ions which flow through the composite membranes and into the fresh water. This charge separation produces a potential difference that can be utilized directly as electrical energy. The voltage obtained depends on factors such as the number of composite membranes in a stack, the difference in ion concentrations across the composite membranes, the internal resistance and the electrode properties.

For all its potential benefits, a significant obstacle to the commercial use of RED to generate energy is the high price of the necessary anionic and cationic composite membranes. Hitherto the price of the composite membranes has been a major factor in the final high kWh price. Turek concluded that prognosis for reducing composite membrane costs to the level necessary for making sea/fresh water RED energy generation a commercially viable proposition was not good. Therefore membrane cost reduction represents a major hurdle to the commercial implementation of blue energy. Since the Turek article the cost of fossil fuels has increased dramatically.

U.S. Pat. No. 4,923,611 describes a process for preparing ion exchange membranes for conventional (as opposed to reverse) electrodialysis. The process was slow and energy intensive, requiring 16 hours to cure the membrane and temperatures of 80° C. Similarly the processes used in U.S. Pat. No. 4,587,269 and U.S. Pat. No. 5,203,982 took 17 hours at 80° C.

WO 2006/102490 A2 describes a continuous process for coating ePTFE with a polymer dispersion followed by drying in an oven, e.g. in three zones set at 40° C., 60° C. and 90° C.

U.S. Pat. No. 5,282,971 describes a slow and energy intensive method for preparing a filter medium. The method comprised grafting a curable composition containing a monomer having quaternary ammonium groups onto a microporous polyvinylidene fluoride membrane rolled with Reemay® interleaf 2250. The grafting step (as illustrated in Example 1) required irradiation with ⁶⁰Co at a dosage of 60,000 rad/hour for 30 hours at 27° C. (80° F.), followed by 4 hours washing and then drying at 100° C. for 10 minutes.

The present invention seeks to provide a rapid and cost effective process for providing composite membranes, especially ion exchange membranes, particularly for use in RED and for the generation of blue energy.

According to a first aspect of the present invention there is provided a continuous process for preparing a composite membrane comprising the steps of:

(i) providing a laminate structure comprising a barrier layer and a porous sheet;

(ii) applying a curable composition to the porous sheet;

(iii) curing the composition to form the composite membrane comprising the sheet and the cured composition; and

(iv) optionally separating the composite membrane from the barrier layer.

Hitherto composite membranes have generally been made in slow and energy intensive processes, often having many stages. The present invention enables the manufacture of composite membranes in a simple process that may be run continuously for long periods of time to mass produce composite membranes relatively cheaply. The presence of the barrier layer has the advantage of preventing the composition from fouling surfaces underneath the porous sheet, especially when the curable composition has a low viscosity. Additionally the barrier layer provides strength to the laminate structure which may facilitate handling in continuous processing, especially at high speeds.

The composite membrane is preferably an anion exchange composite membrane or a cation exchange composite membrane.

The laminate structure comprising the barrier layer (which may also be referred to as a barrier sheet) and a porous sheet may be provided by a process comprising applying one of the barrier layer and the porous sheet to the other. For example, one may provide a pre-prepared roll carrying both the barrier layer and the porous sheet. This can be unwound during the process and the composition applied to the porous layer side in a continuous manner. Alternatively one may provide a roll carrying the barrier layer and a roll carrying the porous sheet and the rolls may be unwound during the process, with the unwound part of the barrier layer sheet being brought into contact with the unwound part of the porous sheet before the curable composition is applied to the porous sheet. In a further alternative the barrier layer may temporarily be brought into contact with the porous sheet by taking the form of an endless belt which passes between the porous sheet and rollers used to move the porous sheet.

The laminate structure may be provided by bringing the porous sheet and barrier layer into contact by applying one to the other, especially while both are moving, preferably by pressing the porous sheet and barrier layer together. When the barrier later comprises and adhesive (e.g. a pressure sensitive adhesive) this pressing can be used to releasably secure the barrier layer and porous sheet together, ensuring the integrity of the laminate structure during steps (ii) and (iii).

Thus the process preferably entails unwinding a roll of barrier layer and a roll of porous sheet and passing the barrier layer and porous sheet over a series of rollers with the barrier layer being positioned between the porous sheet and the rollers. In this way the barrier layer prevents any composition which passes through the porous sheet from fouling the rollers.

The composition may be applied to the porous sheet (which is part of the laminate structure) by any suitable method, for example by curtain coating, slot-die coating, air-knife coating, knife-over-roll coating, blade coating, slide coating, nip roll coating, forward roll coating, reverse roll coating, kiss coating, rod bar coating, spray coating or by a combination of two or more of such methods. The coating of multiple layers can be done simultaneously or consecutively. For simultaneous application of multiple layers of the composition to the porous sheet the preferred methods comprise curtain coating, slide coating and slot die coating.

Thus in a preferred process the composition is applied continuously to the moving porous sheet, more preferably by means of a manufacturing unit comprising a curable composition application station, an irradiation source for curing the composition, a composite membrane collecting station and a means for moving the porous sheet and the barrier layer (e.g. in the form of the laminate) from the composition application station to the irradiation source and to the composite membrane collecting station. The manufacturing unit optionally further comprises a barrier layer collecting station. Such a station is useful for collecting the barrier layer after separation from the composite membrane.

The manufacturing unit preferably further comprises a roll of barrier layer and a roll of porous sheet and means for bringing the barrier layer and porous sheet into contact to form the laminate structure. The composition application station may be located at an upstream position relative to the irradiation source and the irradiation source is located at an upstream position relative to the composite membrane collecting station.

In order to produce a sufficiently flowable composition for application by a high speed coating machine, it is preferred that the curable composition has a viscosity below 4000 mPa.s when measured at 35° C., more preferably from 1 to 1000 mPa.s when measured at 35° C. Most preferably the viscosity of the curable composition is from 1 to 500 mPa.s when measured at 35° C. For coating methods such as slide bead coating the preferred viscosity is from 1 to 150 mPa.s, more preferably from 1 to 100 mPa.s, especially from 2 to 100 mPa.s, when measured at 35° C.

Air pockets inside the composite membrane are preferably prevented as much as possible because they tend to increase the electrical resistance. To reduce the chance of air pockets arising, the viscosity of the composition when it is applied to the porous sheet in step (ii) is preferably below 150 mPa.s, more preferably from 5 to 100 mPa.s, especially 10 to 70 mPa.s. These viscosities may be achieved by appropriate selection of the components used to make the composition and/or by increasing the temperature of the composition such that the desired viscosity is achieved.

With suitable coating techniques, the curable composition may be applied to the porous sheet as the porous sheet moves at a speed of over 15 m/minute, e.g. more than 20 m/minute or even higher, such as 30 m/minute or more, 60 m/minute or more, 120 m/minute or more or up to 400 m/minute, can be reached.

Before applying the curable composition to the surface of the porous sheet this sheet may be subjected to a corona discharge treatment, glow discharge treatment, flame treatment, ultraviolet light irradiation treatment, chemical treatment or the like, e.g. for the purpose of improving its wettability and the adhesiveness.

In one embodiment at least two curable compositions are coated (simultaneously or consecutively) onto the porous sheet. Thus coating may be performed more than once, either with or without curing being performed between each coating step. As a consequence a composite membrane may be formed comprising at least one top layer and at least one bottom layer that is closer to the barrier layer than the top layer.

During curing, monomers, oligomers and/or polymers react together to form covalent bonds therebetween and produce a higher molecular weight chemical. Typically crosslinking agent(s) are present to form a polymer.

The curing may be brought about by any suitable means, e.g. by irradiation and/or heating (e.g. by irradiating with infrared light). If desired further curing may be applied subsequently to finish off. Preferably the curing is performed by irradiating the composition, especially with UV light or with electron beam (“EB”) radiation.

Curing in step (iii) is preferably performed by radical polymerisation, preferably using electromagnetic radiation. The source of radiation may be any source which provides the wavelength and intensity of radiation necessary to cure the composition.

To reach the desired dose of radiation to cure the composition at high coating speeds, step (iii) optionally comprises irradiation of the composition with more than one UV lamp. When two or more UV lamps are used the lamps may apply an equal dose of UV light or they may apply different doses of UV light. For instance, a first lamp may apply a higher or lower dose to the composition than a subsequent lamp. When more than one such UV lamp is used the lamps may emit the same or different wavelengths of light. The use of different wavelengths of light can be advantageous to achieve good curing properties, for example when one lamp emits light of a wavelength which achieves a good surface cure (e.g. a H-bulb) and another lamp emits light of a wavelength which achieves a good cure depth (e.g. a D-bulb), in combination with suitable photoinitiators.

When no photo-initiator is included in the composition, the composition can be cured by electron-beam exposure, e.g. using a dose of 20 to 100 kGy. Curing can also be achieved by plasma or corona exposure. Curing may be done in air or in an inert atmosphere such as N₂ or CO₂.

The curing may be achieved, if desired, thermally (e.g. by irradiating with infrared light) or by irradiating the composition with visible or ultraviolet light or an electron beam.

For thermal curing the curable composition preferably comprises one or more thermally reactive free radical initiators, preferably being present in an amount of 0.01 to 5 parts per 100 parts of curable and crosslinkable components in the composition, wherein all parts are by weight.

Examples of thermally reactive free radical initiators include organic peroxides, e.g. ethyl peroxide and/or benzyl peroxide; hydroperoxides, e.g. methyl hydroperoxide, acyloins, e.g. benzoin; certain azo compounds, e.g. α,α′-azobisisobutyronitrile and/or γ,γ′-azobis(γ-cyanovaleric acid); persulfates; peracetates, e.g. methyl peracetate and/or tert-butyl peracetate; peroxalates, e.g. dimethyl peroxalate and/or di(tert-butyl) peroxalate; disulfides, e.g. dimethyl thiuram disulfide and ketone peroxides, e.g. methyl ethyl ketone peroxide. Temperatures in the range of from about 30° C. to about 150° C. are generally employed for infrared curing. More often, temperatures in the range of from about 40° C. to about 110° C. are used.

Preferably curing of the composition begins within 3 minutes, more preferably within 60 seconds, especially within 15 seconds, more especially within 5 seconds of the composition being applied to the porous sheet.

Preferably the curing is achieved by irradiating the composition for less than 30 seconds, more preferably less than 10 seconds, especially less than 5 seconds, and more especially less than 2 seconds. In a continuous process the irradiation occurs continuously and the speed at which the curable composition moves through the beam of the irradiation is mainly what determines the time period of curing.

Preferably the curing uses visible and/or ultraviolet light. Suitable wavelengths are for instance blue-violet (550 to >400 nm), UV-A (400 to >320 nm), UV-B (320 to >280 nm), UV-C (280 to 200 nm), provided the wavelength matches with the absorbing wavelength of any photo-initiator included in the composition.

Suitable sources of ultraviolet light are mercury arc lamps, carbon arc lamps, low pressure mercury lamps, medium pressure mercury lamps, high pressure mercury lamps, swirlflow plasma arc lamps, metal halide lamps, xenon lamps, tungsten lamps, halogen lamps, lasers and ultraviolet light emitting diodes. Particularly preferred are ultraviolet light emitting lamps of the medium or high pressure mercury vapour type. The energy output of the irradiation source is preferably from 20 to 1000 W/cm, preferably from 40 to 500 W/cm but may be higher or lower as long as the desired exposure dose can be realized. Exposure times can be chosen freely but preferably are short and are typically less than 2 seconds. A typical example of a UV light source for curing is an H-bulb with an output of 600 Watts/inch (240 W/cm) as supplied by Fusion UV Systems. This light source has emission maxima around 220 nm, 255 nm, 300 nm, 310 nm, 365 nm, 405 nm, 435 nm, 550 nm and 580 nm. Alternatives are the V-bulb and the D-bulb which have different emission spectra with main emissions between 350 and 450 nm and above 400 nm respectively.

The composite membrane may be separated from the barrier layer as part of the process if desired. Alternatively the composite membrane may be left in contact with the barrier layer. This latter option has certain advantages, for example the barrier layer can usefully prevent the membrane from sticking to itself during storage and/or transportation, to be removed at a later time before use.

The process may be performed in a continuous manner for long periods of time without significant interruption. New rolls of barrier layer and porous sheet may be attached to the ends of existing rolls being used in the process so as to minimise down time. For example, the process may be run for more than an hour or even for more than a day without stopping.

The process optionally further comprises the step of rolling the product of step (iv) (which may or may not comprise the barrier layer) onto a core for subsequent storage and/or transportation.

The process of the present invention may contain further steps if desired, for example washing and/or drying the membrane. When the composition comprises curable compounds having groups which are convertible to acidic or basic groups the process may further comprise the step of converting the groups which are convertible to acidic or basic groups into acidic or basic groups.

In one embodiment, the thickness of the composite membrane is preferably less than 200 μm, more preferably between 10 and 150 μm, especially between 20 and 120 μm.

In another embodiment the thickness of the composite membrane is preferably less than 500 μm, more preferably between 10 and 300 μm, especially between 20 and 250 μm, more especially between 20 and 120 μm and most preferably between 80 and 220 μm.

Preferably the composite membrane has an ion exchange capacity of at least 0.3 meq/g, more preferably of at least 0.5 meq/g, especially more than 1.0 meq/g, more especially more than 1.5 meq/g, based on the total dry weight of the membrane and any porous sheet and any porous strengthening material which remains in contact with the resultant membrane. Ion exchange capacity may be measured by titration.

The process of the present invention may be used to prepare composite membranes having low electrical resistance, which is particularly useful for composite membranes intended for use in electro-chemical processes.

One of the ways of lowering electrical resistance of the composite membrane is to use a porous sheet having a density below 150 g/m², more preferably below 100 g/m² especially below 75 g/m².

Preferably the composite membrane has a charge density of at least 20 meq/m², more preferably at least 30 meq/m², especially at least 40 meq/m², based on the area of a dry membrane. Charge density may be measured by the same method as used for ion exchange capacity.

Preferably the composite membrane has a power density of at least 0.4 W/m², more preferably at least 0.8 W/m², especially at least 1 W/m², more especially at least 1.3 W/m². The power density is enhanced by, for example, a low electrical resistance of the composite membrane.

Preferably the composite membrane has a permselectivity for small anions (e.g. Cl⁻) of more than 75%, more preferably of more than 80%, especially more than 85% or even more than 90%. Preferably the membrane has a permselectivity for small cations (e.g. Na⁺) of more than 75%, more preferably of more than 80%, especially more than 85% or even more than 90%.

Preferably the composite membrane has an electrical resistance less than 30 ohm/cm², more preferably less than 10 ohm/cm², especially less than 5 ohm/cm², more especially less than 3 ohm/cm².

Preferably the membrane exhibits a swelling in water of less than 50%, more preferably less than 30%, especially less than 20%, more especially less than 10%. The degree of swelling can be controlled by, for example, selecting appropriate parameters in the curing step.

The water uptake of the composite membrane is preferably less than 50% based on weight of dry membrane, more preferably less than 40%, especially less than 30%.

Electrical resistance, permselectivity and % swelling in water may be measured by the methods described by Djugolecki et al, J. of Membrane Science, 319 (2008) on pages 217-218.

Typically the composite membrane is substantially non-porous e.g. the pores are smaller than the detection limit of a standard Scanning Electron Microscope (SEM). Thus using a Jeol JSM-6335F Field Emission SEM (applying an accelerating voltage of 2 kV, working distance 4 mm, aperture 4, sample coated with Pt with a thickness of 1.5 nm, magnification 100,000x, 3° tilted view) the average pore size is generally smaller than 5 nm.

The function of the barrier layer is to prevent any curable composition applied to one side of the porous sheet from fouling surfaces on the other side of the sheet, for example, rollers used to move the porous sheet. When cure speed is fast the barrier layer may be porous because there is insufficient time for the composition to pass through both the porous sheet and the barrier layer. On the other hand, when the cure speed is slower the barrier layer is preferably non-porous. Hence the process of the present invention which uses a barrier layer allows webhandling at high speeds.

The barrier layer is preferably a flexible substrate. This is so that the barrier layer can easily be unwound from a roll during formation of the laminate structure. Ideally the barrier layer is constructed from an inexpensive material. Especially good barrier layers are impervious to the composition.

As examples of porous barrier layers there may be mentioned paper (e.g. pigment coated paper), expanded polyester films, woven or non-woven fabrics and ultrafiltration membranes.

As examples of non-porous barrier layers there may be mentioned metal foil, resin coated paper, polyolefins (e.g. polyethylene and polypropylene), vinyl copolymers (e.g. polyvinyl acetate, polyvinyl chloride and polystyrene), polysulfone, polyphenylene oxide, polyimide, polyamide (e.g. 6,6-nylon and 6-nylon), polyesters (e.g. polyethylene terephthalate, polyethylene-2 and 6-naphthalate and polycarbonate), and cellulose acetates (e.g. cellulose triacetate, cellulose diacetate and cellulose acetate butyrate).

The barrier layer preferably comprises an adhesive which releasably secures the porous sheet thereto. In this way the barrier adheres to the porous sheet and may be peeled off before the composite membrane is used. The adhesive is preferably stable to irradiation and resistant to heat, moisture and exposure to chemicals, with UV and heat stable adhesives being particularly preferred. Preferably the adhesive has a high cohesive strength and a low adhesive strength because this facilitates easy separation of the porous sheet and barrier layer. Preferably the adhesive is a pressure sensitive adhesive (“PSA”).

PSAs form a bond between the barrier layer and the porous sheet when pressure is applied thereto. As the name “pressure sensitive” indicates, the degree of bond is influenced by the amount of pressure which is used.

Preferred PSAs are comprise an elastomer compounded with a tackifier (e.g., a rosin ester). Typical elastomers include natural rubber, nitriles, butyl rubber, acrylics, styrene block copolymers, styrene-butadiene-styrene copolymers (useful when high-strength is required), styrene-isoprene-styrene (useful; when low-viscosity and high-tack are required), styrene-ethylene/butylene-styrene (useful in low adherence is required), styrene-ethylene/propylene, vinyl ethers, ethylene-vinyl acetate with high vinyl acetate content (useful as a hot-melt PSA) and silicone rubbers.

Particularly preferred adhesives are Duro-Tak® pressure sensitive adhesives having high cohesive strength and low to moderate adhesive strength. Such adhesives are available from National Adhesives, NSC Verwaltungs-GmbH, Kleve, Germany (a Henkel company).

When the process comprises application of the curable composition to the porous sheet at a speed of over 15 m/minute, the barrier layer preferably comprises an adhesive having a high shear.

Preferably the adhesive is a crosslinked adhesive, especially a highly crosslinked adhesive. This preference arises because such adhesives can facilitate easy separation of the porous sheet and barrier layer, even after exposure to irradiation and heat. Preferably the adhesive is a versatile solvent based acrylic ester based polymer having a well balanced peel, tack and shear.

The porous sheet may be inorganic or organic, preferably organic. Preferred organic porous sheets are polymeric. Examples of porous sheets include, e.g. a woven or non-woven synthetic fabric, e.g. polyethylene, polypropylene, polyacrylonitrile, polyvinyl chloride, polyester, polyamide, and copolymers thereof, or porous membranes based on e.g. polysulfone, polyethersulfone, polyphenylenesulfone, polyphenylenesulfide, polyimide, polyethermide, polyamide, polyamideimide, polyacrylonitrile, polycarbonate, polyacrylate, cellulose acetate, polypropylene, poly(4-methyl 1-pentene), polyinylidene fluoride, polytetrafluoroethylene, polyhexafluoropropylene, polychlorotrifluoroethylene, and copolymers thereof.

Commercially available non-woven porous sheets are available, e.g. from Freudenberg Filtration Technologies KG (Novatexx materials) and woven sheets are available from Sefar AG.

Preferably the sheet has a hydrophilic character. Surprisingly ion exchange membranes with weakly basic or acidic groups (e.g. tertiary amino, carboxyl and phosphato groups) can exhibit good properties in terms of their permselectivity and conductivity while at the same time being not overly expensive to manufacture by the present process.

The composite membranes of the invention are primarily intended for use in reverse electrodialysis, especially for the generation of blue energy. However it is envisaged that the membranes have other uses, e.g. in electrodialysis, electrodeionisation, continuous electrodeionisation and other water purification applications. The composite membranes may be used in the devices described in, for example, U.S. Pat. No. 5,762,774, WO 2005/090242, US 20050103634 and US 20070175766. The membranes generally have good durability, with low tendency to deteriorate in use. They are also quite durable against higher temperatures and pH.

The porous sheet provides strength to the composite membrane and has a relatively large pore size compared to the separation layer. Thus the porous sheet preferably has an average pore size of 5 to 250 μm, more preferably 10 to 200 μm, especially 20 to 100 μm, as measured prior to application of the separation layer thereto (e.g. using a capillary flow porometer). This can be compared to the average pore size of final composite membrane which is much smaller, preferably 0.0001 to 4 μm, more preferably 0.0001 to 0.1 μm, especially 0.0001 to 0.01 μm. In another embodiment the average pore size of final composite membrane is 0.0002 to 1 μm, especially 0.0005 to 0.1 μm.

In an especially preferred embodiment the average pore size is smaller than 0.5 nm. This ensures the membrane has a low water permeability. Preferably the membrane has a water permeability lower than 1.10⁻⁷ m³/m².s.kPa, more preferably lower than 1.10⁻⁸ m³/m².s.kPa, especially lower than 5.10⁻⁹ m³/m².s.kPa, more especially lower than 1.10⁻⁹ m³/m².s.kPa. The preferred water permeability depends to some extent on the intended use of the membrane.

Preferably the porous sheet is not a fluorinated polyolefin.

The curable composition preferably comprises (a) a compound having one ethylenically unsaturated group; and (b) a crosslinking agent.

Component (a) may be a single compound having one ethylenically unsaturated group or a combination of one or more of such compounds. Typically component (a) comprises:

(ai) a compound having one ethylenically unsaturated group and optionally an acidic group, a basic group or a group that can be converted into an acidic or basic group; and optionally

(aii) a compound having one ethylenically unsaturated group and being free from acidic groups, basic groups and groups that can be converted into an acidic or basic group.

Preferably the acidic or basic groups which may be present on the polymeric separation layer are derived from a copolymerisable substance included in the composition. For example, these acidic or basic groups may conveniently be obtained by selecting component (a) and/or (b) and/or a further component of the composition to have one or more groups selected from acidic groups, basic groups and groups which are convertible to acidic or basic groups.

When the compound has groups which are convertible to acidic or basic groups the process for preparing the membrane preferably comprises the step of converting such groups into acidic or basic groups, e.g. by a condensation or etherification reaction. Preferred condensation reactions are nucleophilic substitution reactions, for example the membrane may have a labile atom or group (e.g. a halide) which is reacted with a nucleophilic compound having a weakly acidic or basic group to eliminate a small molecule (e.g. hydrogen halide) and produce a membrane having the desired acidic or basic group. An example of a hydrolysis reaction is where the membrane carries side chains having ester groups which are hydrolysed to acidic groups.

Preferably the acidic groups are weakly acidic groups and the basic groups are weakly basic groups.

Preferred weakly acidic groups are carboxy groups and phosphato groups.

These groups may be in the free acid or salt form, preferably in the free acid form. Preferred weakly basic groups are secondary amine and tertiary amine groups. Such secondary and tertiary amine groups can be in any form, for example they may be cyclic or acyclic. Cyclic secondary and tertiary amine groups are found in, for example, imidazoles, indazoles, indoles, triazoles, tetrazoles, pyrroles, pyrazines, pyrazoles, pyrolidinones, triazines, pyridines, pyridinones, piperidines, piperazines, quinolines, oxazoles and oxadiazoles. The groups which are convertible to weakly acidic groups include hydrolysable ester groups.

The groups which are convertible to weakly basic groups include haloalkyl groups (e.g. chloromethyl, bromomethyl, 3-bromopropyl etc.). Haloalkyl groups may be reacted with amines to give weakly basic groups. Examples of compounds having groups which are convertible into weakly basic groups include methyl 2-(bromomethyl)acrylate, ethyl 2-(bromomethyl)acrylate, tert-butyl α-(bromomethyl)acrylate, isobornyl a-(bromomethyl)acrylate, 2-bromo ethyl acrylate, 2-chloroethyl acrylate, 3-bromopropyl acrylate, 3-chloropropyl acrylate, 2-hydroxy-3-chloropropyl acrylate and 2-chlorocyclohexyl acrylate.

Examples of suitable compounds which may be used as component (ai) there may be mentioned compounds comprising one ethylenically unsaturated group and a weakly acidic group, e.g. acrylic acid, beta carboxy ethyl acrylate, phosphonomethylated acrylamide, maleic acid, maleic acid anhydride, carboxy-n-propylacrylamide and (2-carboxyethyl)acrylamide; compounds comprising one ethylenically unsaturated group and a weakly basic group, e.g. N,N-dialkyl amino alkyl acrylates, e.g. dimethylaminoethyl acrylate and dimethylaminopropyl acrylate, and acrylamide compounds having weakly basic groups, e.g. N,N-dialkyl amino alkyl acrylamides, e.g. dimethylaminopropyl acrylamide and butylaminoethyl acrylate; and combinations thereof.

Examples of suitable compounds which may be used as component (aii) there may be mentioned 2-hydroxyethyl acrylate, polyethylene glycol monoacrylate, hydroxypropyl acrylate, polypropylene glycol monoacrylate, 2-methoxyethyl acrylate, 2-phenoxyethyl acrylate, and combinations thereof.

Curable compositions containing crosslinking agent(s) can sometimes be rather rigid and in some cases this can adversely affect the mechanical properties of the resultant membrane. However too much of ethylenically unsaturated compounds having only one ethylenically unsaturated group can lead to a membranes with a very loose structure, adversely influencing the permselectivity. Also the efficiency of the curing can reduce when large amounts of curable compound(s) having only one ethylenically unsaturated group are used, increasing the time taken to complete curing and potentially requiring inconvenient conditions therefore. Bearing these factors in mind, the composition preferably comprises 10 to 98 wt % (e.g. 10 to 90 wt %), more preferably 30 to 96 wt % (e.g. 30 to 75 wt %), especially 40 to 95 wt % (e.g. 40 to 60 wt %), of component (a) (including (ai) and (aii)). Especially preferably the composition comprises a high amount of component (ai) because this results in a high amount of charged groups and provides the membrane with a low electrical resistance.

The curable composition may of course contain further components in addition to those specifically mentioned above. For example the curable composition optionally comprises one or more further crosslinking agents and/or one or more further curable compounds.

Component (a) is unable to crosslink because it has only one ethylenically unsaturated group (e.g. one H₂C=CHCO₂— or H₂C=CHCON<group). However it is able to react with other components present in the curable composition. Component (a) can provide the resultant membrane with a desirable degree of flexibility. When it carries an acidic or basic group (or a group convertible to such a group) it can also assists the membrane in distinguishing between ions of different charges by the presence of acidic or basic groups in the final composite membrane.

Examples of suitable crosslinking agent(s) include poly(ethylene glycol) diacrylate, bisphenol A ethoxylate diacrylate, tricyclodecane dimethanol diacrylate, neopentyl glycol ethoxylate diacrylate, propanediol ethoxylate diacrylate, butanediol ethoxylate diacrylate, hexanediol diacrylate, hexanediol ethoxylate diacrylate, poly(ethylene glycol-co-propylene glycol) diacrylate, poly(ethylene glycol)-block-poly(propylene glycol)-block-poly(ethylene glycol) diacrylate, a diacrylate of a copolymer of polyethylene glycol and other building blocks e.g. polyamide, polycarbonate, polyester, polyimide, polysulfone, glycerol ethoxylate triacrylate, trimethylolpropane ethoxylate triacrylate, trimethylolpropane ethoxylate triacrylate, pentaerythrytol ethoxylate tetraacrylate, ditrimethylolpropane ethoxylate tetraacrylate, dipentaerythrytol ethoxylate hexaacrylate and combinations thereof. Especially preferred are tricyclodecane dimethanol diacrylate, isophorone diacrylamide, N,N′-(1,2-dihydroxyethylene) bis-acrylamide, N,N-methylene-bis-acrylamide, 1,3,5-triacryloylhexahydr-1,3,5-triazine, 2,4,6-triallyloxy-1,3,5-triazine, N,N′-ethylenebis(acrylamide), bis(aminopropyl)methylamine diacrylamide, 1,4-diacryoyl piperazine and 1,4-bis(acryloyl)homopiperazine.

In one embodiment, component (b) is preferably present in the curable composition in an amount of 20 to 90 wt %, more preferably 30 to 80 wt %, more especially 40 to 60 wt %.

In another embodiment, component (b) is preferably present in the curable composition in an amount of 2 to 75 wt %, more preferably 4 to 70 wt %, more especially 5 to 60 wt %.

Generally component (b) provides strength to the membrane, while potentially reducing flexibility.

In one preferred embodiment the composition comprises at least 25 wt % of component (ai), more preferably 30 to 80, especially 30 to 70 wt % of component (ai).

In another preferred embodiment the composition comprises at least 25 wt % of component (ai), more preferably 30 to 98 wt %, especially 40 to 95 wt % of component (ai).

In a preferred embodiment the composition comprises 0 to 30 wt %, especially 0 to 20 wt % of component (aii).

In one preferred embodiment the weight ratio of component (ai) to component (b) is 0.3 to 3.0, more preferably 0.7 to 2.5, especially 0.9 to 2.

In another preferred embodiment the weight ratio of component (ai) to component (b) is 0.3 to 30, more preferably 0.7 to 25, especially 0.9 to 20, more especially 1 to 10.

The presence in the curable composition of component (a) having one (i.e. only one) ethylenically unsaturated group can impart a useful degree of flexibility to the membrane. Preferably component (a) has one (and only one) acrylic group.

Acrylic groups are of the formula H₂C=CH-C(=O)—. Preferred acrylic groups are acrylate (H₂C=CH-C(=O)-O—) and acrylamide (H₂C=CH-C(=O)-N<) groups of which the latter is more preferred because they can resultant in the composite membrane having improved resistance to hydrolysis.

It has been found that the use of acidic and basic curable compounds yields membranes which are particularly useful for reverse electrodialysis. Furthermore, such membranes may be prepared under mild process conditions (e.g. at ambient temperatures and without using extremes of pH).

Preferably the composition is substantially free from water (e.g. less than 5 wt %, more preferably less than 1 wt %) because this avoids the time and expense of drying the resultant membrane. Preferably the composition is substantially free from organic solvents (e.g. less than 5 wt %, more preferably less than 1 wt %) because this makes the manufacturing process more environmentally friendly. The word ‘substantially’ is used because it is not possible to rule out the possibility of there being trace amounts of water or organic solvent in the components used to make the composition (because they are unlikely to be perfectly dry).

The use of acidic and basic curable compounds has the advantage of avoiding the need to include water in the composition and in turn this avoids or reduces the need for energy intensive drying steps in the process.

When the composition is substantially free from water the components of the composition will typically be selected so that they are all liquid at the temperature at which they are applied to the sheet or such that any components which are not liquid at that temperature are soluble in the remainder of the composition. When the components are not liquid at ambient temperatures the process may comprise the step of increasing the temperature of at least one of the components of the composition above its melting temperature to achieve a liquid composition. Increasing the temperature has the additional advantage of lowering the viscosity of the composition, although on the other hand it may increase the overall cost of performing the process.

Preferably the curable composition is substantially free from methacrylic compounds (e.g. methacrylate and methacrylamide compounds), i.e. the composition comprises at most 10 wt % (more preferably at most 5%) of compounds which are free from acrylic groups and comprise one or more methacrylic groups.

The curable composition may comprise one or more than one crosslinking agent comprising at least two ethylenically unsaturated groups. When the curable composition comprises more than one crosslinking agent comprising at least two ethylenically unsaturated groups none, one or more than one of such crosslinking agents may have one or more groups selected from acidic groups, basic groups and groups which are convertible to acidic or basic groups.

The curable composition preferably comprises:

(ai) from 25 to 98 wt % (e.g. 25 to 80 wt %) of a compound comprising one ethylenically unsaturated group and an acidic group, a basic group or a group that can be converted into an acidic or basic group;

(aii) from 0 to 20 wt % of one compound comprising an ethylenically unsaturated group and being free from acidic groups, basic groups and groups that can be converted into a acidic or basic groups;

(b) from 2 to 75 wt % (e.g. 20 to 75 wt %) of a crosslinking agent having at least two ethylenically unsaturated groups; and

(c) from 0.1 to 15 wt % (e.g. 0.1 to 10 wt %) of photoinitiator.

The curable composition may contain other components, for example surfactants, viscosity enhancing agents, surface tension modifiers, biocides or other ingredients.

While this does not rule out the presence of other components in the composition (because it merely fixes the relative ratios of components (a), (b) and (c)), preferably the number of parts of (a)+(b)+(c) add up to 100.

Preferably the composition is substantially free from divinyl benzene.

Preferably the composition is substantially free from styrene.

Photo-initiators may be included in the curable composition and are usually required when curing uses UV or visible light radiation. Suitable photo-initiators are those known in the art such as radical type, cation type or anion type photo-initiators.

For acrylamides, bisacrylamides, acrylates, diacrylates, and higher-acrylates, type I photo-initiators are preferred. Examples of I photo-initiators are as described in WO 2007/018425, page 14, line 23 to page 15, line 26, which are incorporated herein by reference thereto. Especially preferred photoinitiators include alpha-hydroxyalkylphenones (e.g. 2-hydroxy-2-methyl-1-phenyl propan-1-one, 2-hydroxy-2-methyl-1-(4-tert-butyl-) phenylpropan-1-one, 2-hydroxy-[4′-(2-hydroxypropoxy)phenyl]-2-methylpropan-1-one, 2-hydroxy-1-[4-(2-hydroxyethoxy)phenyl]-2-methyl propan-1-one, 1-hydroxycyclohexylphenylketone and oligo[2-hydroxy-2-methyl-1-{4-(1-methylvinyl)phenyl}propanone]), alpha-aminoalkylphenones (e.g. 2-benzyl-2-(dimethylamino)-4′-morpholino-butyrophenone and 2-methyl-4′-(methylthio)-2-morpholinopropiophenone), alpha-sulfonylalkylphenones, acetophenones (e.g. 2,2-Dimethoxy-2-phenylacetophenone), thioxanthoses (e.g. isopropyl thioxanthone) and acylphosphine oxides (e.g. 2,4,6-trimethylbenzoyl-diphenylphosphine oxide, bis(2,6-dimethoxybenzoyl)-2,4,4 trimethylpentylphosphineoxide, ethyl-2,4,6-trimethylbenzoylphenylphosphinate and bis(2,4,6-trimethylbenzoyl)-phenylphosphine oxide). Combinations of photoinitiators may also be used.

Preferably the ratio of photo-initiator to the remainder of the curable components in the composition is between 0.0001 and 0.2 to 1, more preferably between 0.001 and 0.1 to 1, based on weight.

Curing rates may be increased by including an amine synergist in the composition. Suitable amine synergists are e.g. free alkyl amines such as triethylamine, methyldiethanol amine, triethanol amine; aromatic amine such as 2-ethylhexyl-4-dimethylaminobenzoate, ethyl-4-dimethylaminobenzoate and also polymeric amines as polyallylamine and its derivatives. Curable amine synergists such as ethylenically unsaturated amines (e.g. acrylated amines) are preferable since their use will give less odour due to their ability to be incorporated into the membrane by curing and also because they may contain a weakly basic group which can be useful in the final membrane. The amount of amine synergists is preferably from 0.1-10 wt. % based on the weight of polymerizable compounds in the composition, more preferably from 0.3-3 wt. %.

Where desired, a surfactant or combination of surfactants may be included in the composition as a wetting agent or to adjust surface tension. Commercially available surfactants may be utilized, including radiation-curable surfactants. Surfactants suitable for use in the composition include non-ionic surfactants, ionic surfactants, amphoteric surfactants and combinations thereof.

Preferred surfactants are as described in WO 2007/018425, page 20, line 15 to page 22, line 6, which are incorporated herein by reference thereto. Fluorosurfactants are particularly preferred, especially Zonyl® FSN (produced by E.I. Du Pont).

The permeability to ions can be influenced by the swellability of the membrane and by plasticization. By plasticization compounds penetrate the membrane and act as plasticizer. The degree of swelling can be controlled by the types and ratio of crosslinkable compounds, the extent of crosslinking (exposure dose, photo-initiator type and amount) and by other ingredients.

Other additives which may be included in the curable composition are acids, pH controllers, preservatives, viscosity modifiers, stabilisers, dispersing agents, inhibitors, antifoam agents, organic/inorganic salts, anionic, cationic, non-ionic and/or amphoteric surfactants and the like in accordance with the objects to be achieved.

Preferably the composition is free from compounds having tetralkyl-substituted quaternary ammonium groups.

Preferably the composition is free from compounds having sulpho groups.

Preferably the composition is free from fluoropolymers.

Hitherto membranes have generally been made in slow and energy intensive processes, often having many stages. The present invention enables the manufacture of membranes in a simple process that may be run continuously for long periods of time to mass produce membranes cost effectively.

Steps (ii) and (iii) are preferably performed at temperatures between 10 and 60° C., more preferably 10 and 40° C. While higher temperatures may be used, these are not preferred because they sometimes lead to higher manufacturing costs.

In view of the foregoing, in a preferred process the curable composition is applied to the porous sheet as the porous sheet moves at a speed of over 15 m/minute, curing of the composition begins within 60 seconds of the composition being applied to the porous sheet and the curing is achieved by irradiating the composition for less than 30 seconds.

According to a second aspect of the present invention there is provided a laminate structure comprising a composite membrane and a barrier layer, wherein the composite membrane comprises a porous sheet coated with a cured polymer, especially a radiation cured polymer, more especially a UV cured polymer.

Preferably the cured polymer has been obtained from a curable composition as hereinbefore described.

Preferably the laminate structure is in the form of a roll.

Preferably the laminate structure further comprises an adhesive which releasably secures the composite membrane to the barrier layer.

According to a third aspect of the present invention there is provided use of a composite membrane obtained by the process of the first aspect of the present invention for the generation of electricity.

According to a fourth aspect of the present invention there is provided an electrodialysis or reverse electrodialysis unit comprising at least one anode, at least one cathode and one or more ion exchange membranes obtained by the process of the first aspect of the present invention.

Further the unit preferably comprises an inlet for providing a flow of relatively salty water along a first side of a membrane obtained by the process of the first aspect of the present invention and an inlet for providing a less salty flow water along a second side of the membrane such that ions pass from the first side to the second side of the membrane. Preferably the one or more ion exchange membranes of the unit comprise a membrane obtained by the process of the first aspect of the present invention having weakly acidic groups and a membrane according to the first aspect of the present invention having weakly basic groups. Preferably the membranes are separated by a spacer to prevent that the membranes touch each other and to allow sufficient flow along the membranes.

In a preferred embodiment the unit comprises at least 100, more preferably at least 500, membranes obtained by the process of the first aspect of the present invention. Alternatively, a continuous first membrane obtained by the process of the first aspect of present invention having acidic or basic groups may be folded in a concertina (or zigzag) manner and a second membrane having basic or acidic groups (i.e. of opposite charge to the first membrane) may be inserted between the folds to form a plurality of channels along which fluid may pass and having alternate anionic and cationic membranes as side walls. Preferably the second membrane is obtained by the process of the first aspect of the present invention.

In this specification (including its claims), the verb “comprise” and its conjugations is used in its non-limiting sense to mean that items following the word are included, but items not specifically mentioned are not excluded (unless their exclusion is stated explicitly). In addition, reference to an element by the indefinite article “a” or “an” does not exclude the possibility that more than one of the elements is present, unless the context clearly requires that there be one and only one of the elements. For example “having one” means having one and only one (not including two or more). The indefinite article “a” or “an” thus usually means “at least one”.

The invention will now be illustrated with non-limiting examples where all parts and percentages are by weight unless specified otherwise.

In the examples the following properties were measured by the methods described below:

Permselectivity was measured by using a static composite membrane potential measurement. Two cells are separated by the composite membrane under investigation. Prior to the measurement the composite membrane was equilibrated in a 0.5 M NaCl solution for at least 12 hours. Two streams having different NaCl concentrations were passed through cells on opposite sides of the composite membranes under investigation. One stream had a concentration of 0.1 M NaCl (from Sigma Aldrich, min. 99.5% purity) and the other stream was 0.5 M NaCl. The flow rate was 0.74 litres/minute. Two double junction Ag/AgCl reference electrodes (from Metrohm AG, Switzerland) were connected to capillary tubes that were inserted in each cell and were used to measure the potential difference over the composite membrane. The effective composite membrane area was 3.14 cm² and the temperature was 25° C.

When a steady state was reached, the composite membrane potential was measured (ΔVₘₑₐₛ)

The permselectivity (α (%)) of the composite membrane was calculated according the formula:

α(%)=ΔVₘₑₐₛ/ΔVₜₕₑₒᵣ*100%.

The theoretical composite membrane potential (ΔVₜₕₑₒᵣ) is the potential for a 100% permselective composite membrane as calculated using the Nernst equation.

Electrical resistance was measured by the method described by Djugolecki et al, J. of Composite membrane Science, 319 (2008) on page 217-218 with the following modifications:

the auxiliary composite membranes were from Tokuyama Soda, Japan;

the effective area of the composite membrane was 3.14 cm²;

the pumps used were Masterflex easyload II from Cole-Palmer;

the capillaries were filled with 3 M KCl;

the reference electrodes were from Metrohm; and

cells 1,2,5 and 6 contained 0.5 M Na₂SO₄.

DMAPAA is N-(3-(dimethylamino)propyl) acrylamide, a curable compound having one acrylic group and a weakly basic group, obtained from Kohjin Chemicals, Japan.

SR238 is 1,6-hexanediol diacrylate from Sartomer, France.

SR833S is tricyclodecane dimethanol diacrylate from Sartomer, France.

Irgacure™ 1870 is a photoinitiator obtained from Ciba, Switzerland.

Irgacure™ is a trade mark of Ciba.

Additol ITX is a photoinitator obtained from Cytec Surface Specialties Inc.

Novatexx™ 2473 is a non woven polyethylene/polypropylene material of weight 30 g/m², thickness 0.12 mm having an air permeability of 2500 l/m²/s at 200 Pa from Freudenberg Filtration Technologies KG.

### EXAMPLE 1

### Step (i)—Providing a Laminate Structure Comprising a Barrier Layer and a Porous Sheet

A barrier layer was prepared by applying an adhesive (Duro-Tak™ pressure sensitive adhesive from National Adhesives, NSC Verwaltungs-GmbH, Germany, a Henkel company) to a length polyethylene terephthalate (“PET”, 50 μm thickness). The barrier layer was then wound onto a first spool.

A porous sheet (Viledon Novatexx™ 2473 PP/PE nonwoven porous sheet from Freudenberg Filtration Technologies, Germany) was wound onto a second spool.

The contents of the first and second spools were unwound at a speed of 30 m/minute and passed over a roller which brought the porous sheet into contact with the adhesive side of the barrier layer, thereby forming a moving laminate structure comprising a barrier layer and a porous sheet.

### Step (ii)—Applying a Curable Composition to the Porous Sheet

A curable composition (“CC1”) was prepared by mixing the ingredients shown in Table 1:

TABLE 1

| Ingredient | Amount (wt %) |
|---|---|
| SR238 | 49.22 |
| DMAPAA | 49.22 |
| Irgacure ™ 1870 | 1.25 |
| Zonyl ™ FSN100 | 0.30 |

Note:
CC1 had a viscosity of about 40 mPa · s and a surface tension of about 34 mN/m, as measured at 25° C.

The moving laminate structure was passed over a roller at a speed of 30 m/minute while CC1 was continuously applied to the side showing the porous sheet. CC1 was applied at a rate of 50×10⁻⁶ m³/s per meter width using a multi-layer slide coater.

### Step (iii)—Curing the Composition to Form the Composite Membrane Comprising the Sheet and the Cured Composition

While still moving at a speed of 30 m/minute, the laminate structure carrying CC1 was passed under a UV lamp (an LH-10 lamp from Fusion UV Systems Inc, Maryland, USA). The time between CC1 being applied to the laminate structure and irradiation was 3.6 seconds. The UV exposure time was about 0.5 seconds (peak exposure, not including stray light).

The resultant laminate structure comprised a composite membrane and a barrier layer, wherein the composite membrane comprised a porous sheet (Viledon Novatexx™ 2473 PP/PE) coated with a cured polymer derived from CC1. The PET barrier layer was easily removed from the composite membrane without causing any damage thereto.

### EXAMPLES 2 TO 6

Further curable compositions (C2 to C6) were prepared by mixing the ingredients shown in Table 2.

TABLE 2

| Ingredient | C2 wt % | C3 wt % | C4 wt % | C5 wt % | C6 wt % |
|---|---|---|---|---|---|
| DMAPAA | 49.25 | 49.25 | 49.75 | 49.75 | 49.25 |
| SR238 | | | 49.75 | | |
| SR833S | 49.25 | 49.25 | | 49.75 | 49.25 |
| Irgacure ™ 1870 | 1.0 | 0.5 | | | 0.5 |
| Additol ™ ITX | | 0.5 | | | 0.5 |
| Zonyl ™ FSN100 | 0.5 | 0.5 | 0.5 | 0.5 | 0.5 |

The viscosity and the surface tension of compositions C2 to C6 were between 40 and 60 mPa.s and between 32 and 36 mN/m, as measured at 25° C.

### Steps (i) and (ii)—Application to a Porous Sheet and Curing

Compositions C2 and C3 were applied to a porous sheet and cured exactly as described in Example 1.

Compositions C4 and C5 were applied to a porous sheet using a rod bar in a wet thickness of 110 μm and cured under a nitrogen atmosphere using an ESH150 electron beam unit from Otto Durr. The unit irradiated the coated sheet moving at 14 m/minute, resulting in an exposure time of about 0.5 seconds at a voltage of 175 kV and a dose of about 60 kGray. Composition C6 was applied to the porous sheet as described in Example 1 except that, in addition to step (ii), a 4 μm rod bar was used to smoothen the applied composition and remove surplus composition prior to step (iii).

### RESULTS

The permselectivity and electrical resistance of the resultant membranes were measured using the methods described above. The results are as shown in Table 3:

TABLE 3

| | Curable | Permselectivity | Electrical resistance |
|---|---|---|---|
| Example | Composition | (α (%)) | (ohm/cm²) |
| 1 | C1 | 94.2 | 3.4 |
| 2 | C2 | 93.7 | 4.4 |
| 3 | C3 | 93.1 | 4.6 |
| 4 | C4 | 93.6 | 6.1 |
| 5 | C5 | 93.6 | 5.0 |
| 6 | C6 | 95.4 | 4.4 |

1. A continuous process for preparing a composite membrane comprising the steps of:
providing a laminate structure comprising a barrier layer and a porous sheet;
(ii) applying a curable composition to the porous sheet;
(iii) curing the composition to form the composite membrane comprising the sheet and the cured composition; and
(iv) optionally separating the composite membrane from the barrier layer.

2. A process according to claim 1 wherein the barrier layer comprises an adhesive which releasably secures the porous sheet thereto.

3. The process according to claim 1 wherein the curable coating composition is applied to the porous sheet by curtain coating, slot-die coating, air-knife coating, knife-over-roll coating, blade coating, slide coating, nip roll coating, forward roll coating, reverse roll coating, kiss coating, rod bar coating, spray coating or by a combination of two or more thereof.

4. The process according to claim 1 wherein the curing is performed by irradiating the composition.

5. The process according to claim 4 wherein the curing is achieved by irradiating the composition for less than 30 seconds.

6. The process according to claim 1 wherein the curing is performed by irradiating the composition with UV light or with electron beam radiation.

7. The process according to claim 1 wherein the curable composition is applied to the porous sheet as the porous sheet moves at a speed of over 15 m/minute.

8. The process according to claim 1 wherein the curable composition comprises (a) a compound having one ethylenically unsaturated group; and (b) a crosslinking agent.

9. The process according to claim 8 wherein component (a) comprises:
(ai) a compound having one ethylenically unsaturated group and optionally an acidic group, a basic group or a group that can be converted into an acidic or basic group; and optionally
(aii) a compound having one ethylenically unsaturated group and being free from acidic groups, basic groups and groups that can be converted into an acidic or basic group.

10. The process according to claim 1 wherein there is provided a roll carrying the barrier layer and a roll carrying the porous sheet and the rolls are unwound during the process, with the unwound part of the barrier layer sheet being brought into contact with the unwound part of the porous sheet before the curable composition is applied to the porous sheet.

11. The process according to claim 1 which further comprises the step of rolling the product of step (iv) onto a core for subsequent storage and/or transportation.

12. The process according to claim 1 wherein the porous sheet and a barrier layer are brought into contact by applying one to the other while both are moving.

13. The process according to claim 1 wherein curing of the composition begins within 3 minutes of the composition being applied to the porous sheet.

14. (canceled)

15. The process according to claim 1 wherein the composite membrane comprises acidic groups or basic groups.

16. The process according to claim 1 wherein the curable composition is applied to the porous sheet as the porous sheet moves at a speed of over 15 m/minute, curing of the composition begins within 60 seconds of the composition being applied to the porous sheet and the curing is achieved by irradiating the composition for less than 30 seconds.

17. A laminate structure comprising a composite membrane and a barrier layer comprising an adhesive which releasably secures the composite membrane to the barrier layer, wherein the composite membrane comprises a porous sheet and a cured polymer.

18. An electrodialysis or reverse electrodialysis unit comprising at least one anode, at least one cathode and one or more ion exchange membranes obtained by the process of claim 1.

19. The process according to claim 2 wherein the adhesive is a UV and heat stable adhesive.

20. The process according to claim 2 wherein (i) the curable coating composition is applied to the porous sheet by curtain coating, slot-die coating, air-knife coating, knife-over-roll coating, blade coating, slide coating, nip roll coating, forward roll coating, reverse roll coating, kiss coating, rod bar coating, spray coating or by a combination of two or more thereof, (ii) the curing is performed by irradiating the composition for less than 30 seconds with UV light or with electron beam radiation; and (iii) the curable composition is applied to the porous sheet as the porous sheet moves at a speed of over 15 m/minute.

21. The process according to claim 20 wherein (i) there is provided a roll carrying the barrier and a roll carrying the porous sheet and the rolls are unwound during the process, with the unwound part of the barrier layer sheet being brought into contact with the unwound part of the porous sheet before the curable composition is applied to the porous sheet; (ii) the porous sheet and a barrier layer are brought into contact by applying one to the other while both are moving; and the process further comprises the step of rolling the product of step (iv) onto a core for subsequent storage and/or transportation.

22. The process according to claim 1 wherein curing of the composition begins within minutes of the composition being applied to the porous sheet.
